(19) United States
(12) Patent Application Publication
(10) Pub. No.: US 2025/0187294 A1
(43) Pub. Date: Jun. 12, 2025

(54) COMPOSITE SANDWICH PANEL ASSEMBLY CONTAINING FIBER OPTIC

(71) Applicant: Teijin Automotive Technologies, Inc., Auburn Hills, MI (US)

(72) Inventor: Hugh Foran, Auburn Hills, MI (US)

(73) Assignee: Teijin Automotive Technologies, Inc., Auburn Hills, MI (US)

(21) Appl. No.: 18/968,015

(22) Filed: Dec. 4, 2024

Related U.S. Application Data
(60) Provisional application No. 63/607,213, filed on Dec. 7, 2023.

(51) Int. Cl. B32B 3/14; B32B 3/04; B32B 3/12; B32B 5/02; B32B 27/06; B32B 27/20; B32B 37/12; B32B 38/08

(52) U.S. Cl. CPC B32B 3/14; B32B 3/04; B32B 3/12; B32B 5/02; B32B 27/06; B32B 27/20; B32B 37/1284; B32B 38/08; B32B 2037/1253; B32B 2250/40; B32B 2260/021; B32B 2260/046; B32B 2307/406; B32B 2307/412; B32B 2307/7376; B32B 2310/0831; B32B 2605/00; B32B 2607/00

(57) ABSTRACT

A composite sandwich panel assembly and process for forming a composite sandwich panel assembly. The composite sandwich panel assembly including a first layer having a first face and a second face opposing the first face, a first adhesive provided on the first face of the first layer, a first optical fiber embedded within the first adhesive and having a first end thereof free from the adhesive, and a second layer adhered to the first face of the first layer by the first adhesive. The first adhesive is a UV curable adhesive, and the first optical fiber has a refraction index such that UV light applied to the first end of the first optical fiber is emitted along the length of the first optical fiber to cure the UV curable adhesive.

### RELATED APPLICATIONS

This application claims priority benefit of U.S. Provisional Application Ser. No. 63/607,213 filed 7 Dec. 2023; the contents of which are hereby incorporated by reference.

### FIELD OF THE INVENTION

The present invention in general relates to composites and in particular to a composite sandwich structure assembly with layers of the assembly adhered to one another with a UV curable adhesive that is cured by light emitted from an optical fiber that is embedded within the adhesive.

### BACKGROUND OF THE INVENTION

Weight savings in the automotive, transportation, and logistics based industries has been a major focus in order to make more fuel efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials. A sandwich-structured composite is a special class of composite material that is fabricated by attaching at least two separate pieces of material together, like attaching two thin but stiff skins to a lightweight but thick core. In such examples, the core material is normally a low strength material, but its higher thickness provides the sandwich composite with high bending stiffness with overall low density.

While sandwich structures have previously been developed to provide strength and reduced weight, the ability to obtain a vehicle exterior quality high gloss surface has remained a challenge, regardless of whether the surface outermost layer is thermoset resin or thermoplastic. Exemplary of these efforts are U.S. Pat. Nos. 5,087,500A; 4,803,108A; 8,091,286B2; 4,369,608A; 3,553,054A; and WO2018/202473. It is conventional to either not use such structures in settings where vehicle high surface gloss is required, or resort to an additional outer layer to provide a high gloss outermost layer. Such outermost layers can be applied after structure production or through in mold coatings, both of which add to the cost and complexity of production.

Still another problem conventional to the art is that the separate layers of such sandwich structures are typically held together by an adhesive that requires heating or extended periods of time to cure, adding complexity and time to the assembly process and thereby resulting in a slow throughput. Furthermore, adhesives that are either applied hot or that require heating in order to cure introduce thermal expansion issues into the formation process that create stresses within the assembled part that can lead to failure. Additionally, adhesives typically used for such sandwich structures either cure too quickly or too slowly. That is, an adhesive with a long cure time leads to slow throughput given that the assembled structure needs to set for extended periods of time as the adhesive cures to ensure that the components of the structure do not move relative to one another or else the structure will be ruined and scrapped. On the other hand, an adhesive with a short cure time may lead to faster throughput but tends to increase the scrap rate or the failure rate of the assembled structures given that the components of the structure may not be properly aligned relative to one another before the adhesive starts to cure.

Thus, there exists a need for a sandwich composite structure that is held together with an optimized adhesive that allows positioning of the components thereof relative to one another up until the moment of cure and thereafter that cures quickly without introducing unwanted stresses into the structure in order to reduce scrap and increase throughput of light weight, high strength composite material assemblies.

### SUMMARY OF THE INVENTION

The present invention provides a composite sandwich panel assembly that includes a first layer having a first face and a second face opposing the first face, a first adhesive provided on the first face of the first layer, a first optical fiber embedded within the first adhesive and having a first end thereof free from the adhesive, and a second layer adhered to the first face of the first layer by the first adhesive. The first adhesive is a UV curable adhesive, and the first optical fiber has a refraction index such that UV light applied to the first end of the first optical fiber is emitted along the length of the first optical fiber to cure the UV curable adhesive.

The present invention additionally provides a process for forming the above composite sandwich panel assembly. The process includes applying a first UV curable adhesive on a first face of a first layer, embedding a length of a first optical fiber in the first UV curable adhesive while leaving a first end of the first optical fiber free of the first adhesive, applying a second layer to the first UV curable adhesive on the first face of the first layer, and applying UV light to the first of the first end optical fiber so that the UV light is emitted along the length of the first optical fiber to cure the first UV curable adhesive.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a partial cutaway, perspective view of an inventive composite sandwich assembly with a simple edge;

FIG. 2 is an enlarged partial cutaway, side view of a composite sandwich assembly of FIG. 1 along a line bisecting the hexagonal pores;

FIGS. 3A-3F are top views of various open pore structures operative in the present invention that include hexagonal (FIG. 3A), circular (FIG. 3B), rhomboidal (FIG. 3C), triangular (FIG. 3D), parallelogram quadrilateral (FIG. 3E), and regular quadrilateral (FIG. 3F); and

FIGS. 4A-4D are cross-sectional views of edges according to the present invention.

### DESCRIPTION OF THE INVENTION

The present invention has utility as a sandwich composite structure that is held together with an optimized adhesive that allows positioning of the components thereof relative to one another up until the moment of cure and thereafter that cures quickly without introducing unwanted stresses into the structure in order to reduce scrap and increase throughput of light weight, high strength composite material assemblies. According to embodiments, the composite sandwich panel structure includes a low density core sandwiched between a high gloss surface sheet and a structural skin that are adhered to the open area core using a UV curable adhesive so as to reduce delamination of the formed part. According to embodiments of the inventive sandwich composite structure, the high gloss surface sheet and structural skin are adhered to the open area core with a UV curable adhesive that is viscous when applied and has an optical fiber embedded therein that emits light from a length thereof in order to cure the UV curable adhesive quickly and without additional heat or introduction of stresses into the formed assembly. According to embodiments, the viscosity of the adhesive as applied allows for contact with the interior volume of the open area core to create more adhesion surface area, yet without excessively running into the pores defined in the low-density core before the adhesive cures or hardens thereby providing greater adhered contact area between the components of the inventive sandwich composite structure. As a result, reduced delamination of the components of the inventive sandwich composite structure is observed as well as precluding bond line readthrough into the high gloss surface sheet. It is appreciated that providing a high gloss exterior surface without resort to an additional outmost layer requires a balancing of opposing surface tension properties of the inventive composite sandwich panel structures to avoid a loss in tolerances associated with bowing of the structure. In some embodiments of the present invention, a cloth is positioned intermediate between the open area core and at least one of the high gloss surface sheet or the structural skin. Embodiments of the present invention also have utility as watertight and waterproof composite sandwich panel structures.

The present invention is suitable for all vehicle components made of composite material, but in particular for vehicle body shell components, such as vehicle roof modules, roof posts, A, B, C or D pillars of vehicles, vehicle doors, wings, engine compartment covers, luggage compartment covers, rear-end modules, roof shells of cabriolet hoods, front or rear spoilers. Embodiments of the present invention further provide sound dampening and temperature variation resistance qualities.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, the term “high gloss surface” refers to a surface having minimal perceptible surface defects when visually inspected for about three seconds from about 24-28 inches from the viewer and normal to the part surface +/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss, yet must retain dimensionality and adhesion uniformity to primer and paint so as to achieve a high gloss finish.

Referring now to the figures, an inventive composite sandwich, shown generally at 10, includes a first layer 12 having a first face 17 and a second face 17′ opposing the first face 17 and a second layer 14 adhered to the first face 17 of the first layer 12 by a first adhesive 20. The first adhesive 20 is a UV curable adhesive and has a first optical fiber 40 therein. The first optical fiber 40 has a first end 42, a second end 44, and a length therebetween, the length of the first optical fiber 40 is embedded within the first adhesive 20 and the first end 42 of the first optical fiber 40 is free of the first adhesive 20. The first optical fiber 40 has a refraction index such that UV light applied to the first end 42 of the first optical fiber 40 is emitted along the length of the first optical fiber 40 in order to cure the UV curable adhesive of the first adhesive layer 20. According to some embodiments, the composite sandwich additionally includes a third layer 16 adhered to the second face 17′ of the first layer 12 by a second adhesive 22 provided on the second face 17′ of the first layer 17′. According to embodiments, the second adhesive 22 is a UV curable adhesive with a length of a second optical fiber 40′ embedded therein. The second optical fiber 40′ has a refraction index such that UV light applied to a first end 42′ of the second optical fiber 40′ is emitted along the length of the second optical fiber 40′.

According to embodiments, the first adhesive 20, and when present the second adhesive 22, are each independently a transparent adhesive and have a high degree of optical clarity (e.g., it does not impact the color or intensity of light projected through the adhesive). The optical fibers 40, 40′ are formed of glass fibers and may be laid out in any pattern such as a spiral, switch back, etc. It will also be appreciated that each fiber 40, 40′ may be provided as a plurality of optical fibers that are each embedded within the adhesives 20, 22 along its length and each having at least one end free of the adhesive so that a UV light may be applied thereto.

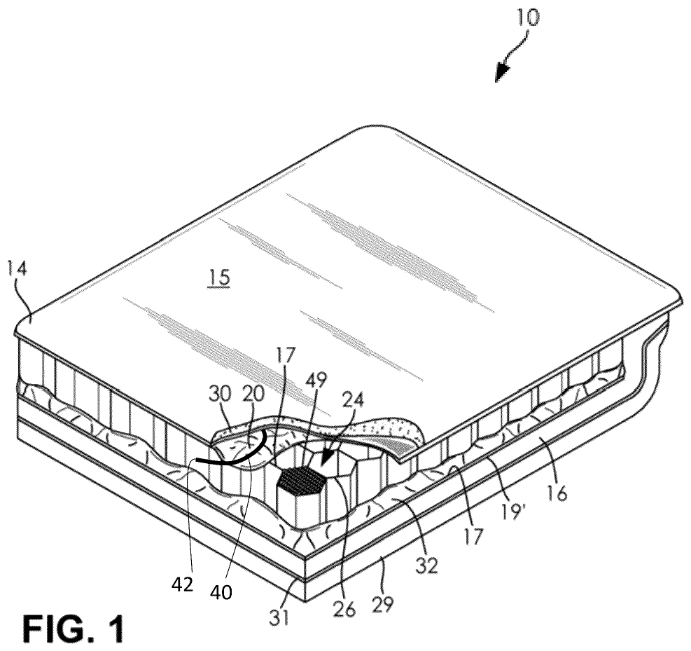

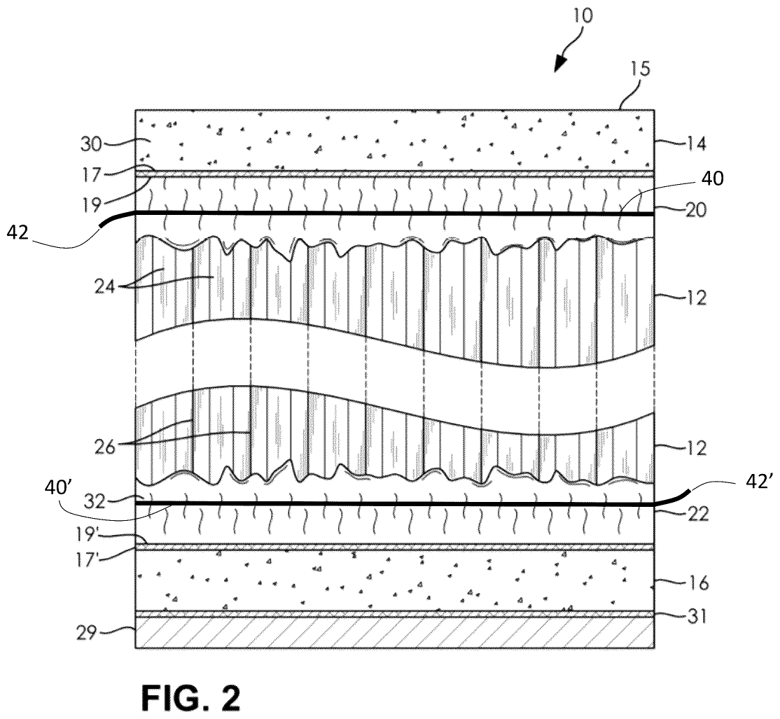

According to embodiments, the first layer 12, the second layer 14, and when present, the third layer 16 are each independently one of a low-density core that defines a plurality of pores, a structural skin, or a high gloss surface sheet. It will be understood that more layers can be added to the incentive assembly. As shown in the figures, in an embodiment of the inventive sandwich 10 the first layer 12 is a low-density core with walls 26 defining an ordered array of pores 24 terminating in faces 17 and 17′. The first layer 12 is positioned between a second layer 14 that is a high gloss surface sheet on one side and a third layer 16 that is a structural skin on an opposite side therefrom. As shown in FIG. 1, a portion of the high gloss surface sheet second layer 14 is cutaway to reveal the first adhesive 20, a cloth 19, if present; and the low-density core first layer 12. The high gloss surface sheet second layer 14 is adhered to a first side 17 of the low-density core 12 by a first adhesive layer 20 and presents an outwardly facing high gloss surface 15. FIG. 2 is an enlarged cross-sectional view of a composite sandwich 10 according to embodiments of the invention showing further details of the various layers making up the composite sandwich. In some inventive embodiments, a cloth 19 is present intermediate between the face 17 of the low-density core first layer 12 and the high gloss surface sheet second layer 14, the cloth 19 embedded within the adhesive 20. In the figures, the structural skin third layer 16 is adhered to an opposing second side 17′ of the low-density core first layer 12 by a second adhesive layer 22. In some inventive embodiments, a cloth 19′ is present intermediate between the second face 17′ of first layer 12 and the structural skin third layer 16, the cloth 19′ embedded within the adhesive 22. While the structure 10 depicted in FIGS. 1 and 2 is planar, it is appreciated that the first layer 12, the second layer 14, and the third layer 16 are each independently formed with non-planar contours. As shown in FIGS. 1 and 2, an optical fiber 40, 40′ is embedded in each of the adhesive layers 20, 22, more specifically, the length of each of the optical fibers 40, 40′ are embedded within the adhesive 20, 22 while at least one end 42, 42′ of the optical fibers 40, 40′ are free such that a UV light is able to be applied thereto.

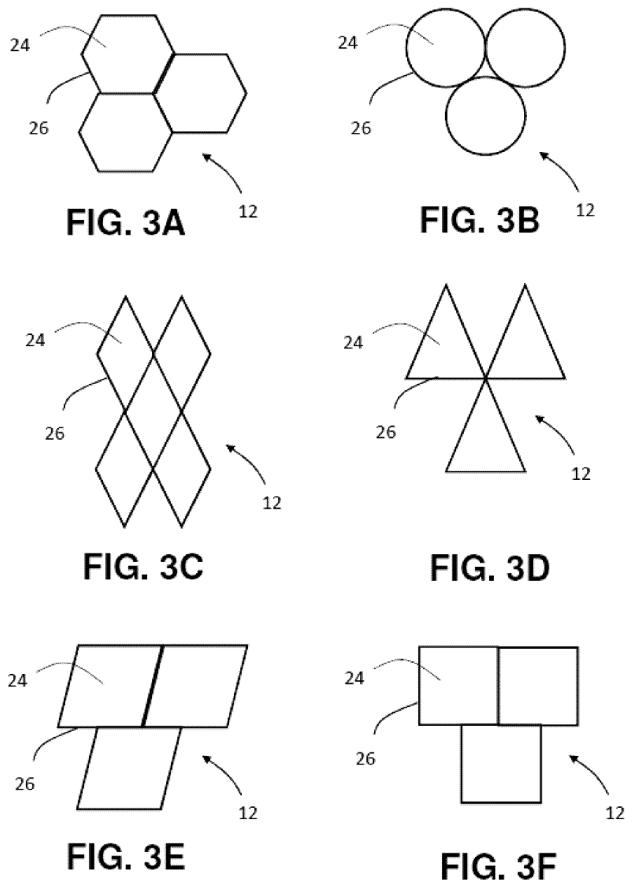

FIGS. 3A-3F show in top view of the edges of walls 26 that define pores 24 in certain embodiments of a low-density core such as 12 depicted in FIGS. 1 and 2. A low-density ore, such as 12 depicted with respect to FIGS. 1 and 2 may use a wall material 26 to define a plurality of pores 24 in a shape that illustratively includes hexagonal (FIG. 3A), circular (FIG. 3B), rhomboidal (FIG. 3C), triangular (FIG. 3D), parallelogram quadrilateral (FIG. 3E), and regular quadrilateral (FIG. 3F). of honeycombs, diamonds, squares, triangles, parallelograms, circles, or a combination thereof. The faces 17 and 17′ of the open area core 12 support the tensioned high gloss surface sheet of the second layer 14 and structural skin third layer 16 when the inventive composite sandwich is assembled and transfer externally applied forces within the structure 10. It is appreciated that while pores are depicted as isolated from one another that wall structures are readily formed from extended folded strips that define a portion of several pores and when made contiguous with other such folded strips define an array of pores that are intercommunicative along the lines of contact between contiguous strips.

According to embodiments, at least some pores 24 of the low-density core 12 are in fluid communication with at least one other pore 24. According to embodiments, the fluid communication is established by forming a transverse hole through a side wall 26 of at least some of the pores 24. Such holes can be formed in the material of the low-density core 12 before the material is formed into the pores of the open are core. Alternatively, the holes allowing for fluid communication between the pores can be formed in the walls 26 of the core 12 after the pores 24 are formed. Fluid communication between at least some of the pores 24 ensures that air that is caught within a pore is able to move to another pore in the event that a given pore is crushed or otherwise deformed. As will be described in greater detail below, in some embodiments the edge region of the core material is crushed to form a sealed edge. In such situations, it is beneficial to provide transverse holes in the walls 26 of at least some of the pores 24, for example those near the edge to be sealed, such that when the seal is formed and the pores 24 near the edge are crushed, the air of those crushed pores is able to move into adjacent pores via the transverse holes.

A low-density core, such as that depicted as the first layer 12 is formed of a lightweight material that defines a plurality of pores 24 so as to reduce the overall density of the low-density core 12. A low-density core according to the present invention is formed from a variety of materials that include cellulosics such as corrugated fiberboard, paper board, paper stock; thermoplastics such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; thermosets such as polyesters, polyureas, polyurethanes, polyurea/polyurethanes, epoxies, vinyl esters; metal such as aluminum, magnesium, and alloys of any one of the aforementioned where at least one of the aforementioned metals constitutes the majority by weight of the alloy; a foam formed from polyurethane, polyethylene, ethylene vinyl acetate, polypropylene, polystyrene, polyvinyl chloride, oraerogels, regardless of whether the foam is open-celled or closed-celled.

According to some inventive embodiments, the pores 24 defined by walls 26 of the low-density core 12 extend between faces 17 and 17′. In some embodiments, the walls 26 are treated to modify a property thereof such as hydrophobicity or surface energy to promote adhesion thereto. By way of example, cellulosics are prone to moisture uptake and are readily coated with a wax such as a paraffin, or a silicone to render the cellulosic more hydrophobic compared to a native state. Alternatively, the cellulosic is readily alkylated by conventional reactions such as those with chloroacetic acid. Sarymsakov, A. A et al., Chem. Nat. Compd. (1997) 33:337. Metals are similarly coated with a primer or other corrosion inhibitor. Alternatively, metals or polymers are plasma treated to modify surface energies to facilitate adhesion thereto.

In certain inventive embodiments, the ratio of the thickness of a wall 26 to the maximal linear extent between faces 17 and 17′ is between 0.01-10:1. A wall thickness ranges from 0.1 mm to 100 mm in such inventive embodiments.

A high gloss surface sheet according to the present invention and as shown for example with respect to the second layer 14 is formed from sheet molding compound (SMC), thermoplastic, dicyclopentadiene (DCPD), overmolded polyurethane (PU), or a combination thereof. According to embodiments, the high gloss surface sheet 14 includes a filler material 30 to reinforce and/or serve to decrease the weight of the high gloss surface sheet 14. The filler material 30 is any of glass fibers, carbon fibers, natural fibers, hollow or solid glass microspheres, or a combination thereof. The fibers may be oriented or non-oriented. In some inventive embodiments in which SMC forms the high gloss surface, a resin package sold by Continental Structural Plastics, Inc. under the tradenames TCA® and TCA® ULTRA-LITE™ are used herein. Exemplary formulations of which are detailed in U.S. Pat. No. 7,700,670; WO2017/184761; and U.S. Pat. No. 7,524,547B2. It is appreciated that the high gloss sheet routinely includes additives to retain dimensionality. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. Typical thicknesses of the high gloss surface sheet in the present invention range from 0.5 to 5 millimeters (mm) without regard to edges.

A high gloss surface sheet such as that depicted as the second layer 14 is adhered to a first side of the low-density core first layer 12 by a first adhesive layer 20. The first adhesive layer 20 is formed of a UV curable formulation. As shown in FIG. 2, due to the compressive force applied to the first adhesive layer 20 between the high gloss surface sheet 14 and the low-density core 12, the adhesive 20 is engineered to have an initial viscosity on contact with the face 17 and the walls 26 so as partially fill the pores 24 of the low-density core 12. It is appreciated that the viscosity upon application is a function of factors that include application temperature, pore dimensions at the face, and intrinsic adhesive viscosity. The viscosity of the first adhesive layer 20 ensures that the adhesive does not excessively run into the pores defined in the low-density core before the adhesive is cured using UV light and attains final strength. Accordingly, the adhesive surface area for adhesion between a high gloss surface sheet and a low-density core is at least 5% more than surface area of the walls at the face. In still other embodiments, the adhesive area is between 5 and 100 surface area percent of the face, and even 100 surface area percent in still other inventive embodiments. This increased surface area of adhesion reduces delamination of the components of the inventive composite sandwich 10 and surprising allows for the use of thinner high gloss surface sheets that do not exhibit bond line read through. As a result of increasing the adhesive surface area coverage from 10 to 50 surface areas percent allows for the comparatively expensive high gloss surface sheet to be reduced in thickness from 1.5 mm to between 1.3 and 0.8 mm while still retaining high gloss through prevention of bond line read through.

As will be understood by a person having ordinary skill in the art, the high gloss surface sheet tends to be a comparatively dense component and an expensive portion to manufacture given the materials used and necessary forming processes to maintain minimal perceptible surface defects suitable for a Class A autobody part. To reduce costs and weight of the inventive composite sandwich panel assembly 10, it is accordingly desirable to reduce the thickness of any high gloss surface sheet 14, making it as thin as possible. It will also be understood that as the thickness of the high gloss surface sheet 14 is decreased the high gloss surface sheet 14 tends to deform when supported by limited portions of the face 17 above the low-density core 12. While result to a large contact surface area of the first adhesive layer 20 is advantageous, in some inventive embodiments a cloth 19 is embedded in the first adhesive layer 20.

The cloth can be woven or nonwoven yet having sufficient porosity to allow the adhesive layer 20 to penetrate therethrough. The cloth 19 providing not only a larger surface area for adhesive layer 20, but also the cloth is believed to function to mitigate surface tension differences relative to structural layer 16 associated with situations such as the manufacturing process, temperature differences in a use environment, and differential force loading during usage. A cloth 19 operative herein illustratively includes fibers of thermoplastic materials such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; carbon fibers; polyaramids; glass fibers in the form as a woven, roving, or lofted sheet; and mixtures of the various fibers. The cloth 19 has a mesh size of 10 to 1000, that is, the mesh layer has 10 to 1000 opening per square inch. The cloth 19 tends to reduce the effects of the walls 26 on the outward appearance of the high gloss surface sheet 14. According to embodiments, the cloth is formed of optical fibers having a refraction index such that UV light applied to ends thereof is emitted along the length of the optical fibers. In such embodiments, the cloth 19 and the first optical fiber 40 are provided as a single component.

As shown in FIGS. 1 and 2, a third layer 16, which according to embodiments is a structural skin, is adhered to the second side of the first layer 12, which here is shown as a low-density core, by a second adhesive layer 22. The structural skin 16 is formed of a fiber mat, a thermoplastic sheet, or an SMC. In some embodiments the SMC is also a high gloss surface as detailed about with respect to reference numeral 14. In inventive embodiments where the structural skin 16 is a fiber mat, the fiber mat is formed of glass fibers. According to certain inventive embodiments, the fiber mat forming the structural skin includes non-oriented, non-woven fibers, unidirectional, or woven fibers. The structural skin third layer 16 is adhered to the second side of the low-density core 12 by a second adhesive layer 22. The second adhesive layer 22 having the attributes of the first adhesive layer detailed above with respect to reference numeral 20. In some inventive embodiments, the same adhesive forms both first adhesive layer 20 and second adhesive layer 22. In still other inventive embodiments, a cloth 19′ is present within the second adhesive layer 22, the cloth 19′ having the attributes of the cloth 19 as detailed above. In some inventive embodiments where both cloths 19 and 19′ are present, the cloths 19 and 19′ are formed of the same material. In still other embodiments, the cloths 19 and 19′ are formed of the same material and have the same thickness. In still other embodiments, the cloths 19 and 19′ are formed of the same material, have the thickness, and are adhered by the same adhesive. In still other embodiments, the surface tension on the high gloss surface sheet 14 and the structural skin 16 are within 10% of one another. In some inventive embodiments, the structural skin 16 terminates against the backside of the high gloss surface sheet 14 to encapsulate the open area core 12.

According to embodiments, the thickness of the open area core first layer 12, the high gloss surface sheet second layer 14, and the structural skin third layer 16 may vary based on design parameters and intended use of a finished component formed from a composite sandwich panel assembly 10 of the present disclosure. As noted above, embodiments of the present disclosure provide a high gloss surface sheet 14 having a thickness of 0.5 to 3.5 mm. The ratio of the high gloss surface sheet 14 average thickness to the low-density core 12 average thickness is 0.01-1:1, while the ratio of the structural skin 16 thickness to the low-density core 12 thickness is 0.05-1:1. In a particular inventive embodiment, the high gloss surface sheet 14 has an average thickness of 1.5 to 5 mm and the low-density core 12 has an average pore diameter of 6 to 25 mm. In some inventive embodiments, the low-density core 12 pore diameter is as much as 42 mm. As used herein, pore diameter is defined as the average of orthogonal pore dimensions measure at a right angle to the pore axis at the interior wall edge at the face 17. By way of example, a circular pore has identical diameter in x- and y-directions relative to the pore axis.

According to some inventive embodiments, a decorative layer 29 is attached to the exposed surface 31 of the structural skin 16. In some embodiments, the decorative layer 29 is a vehicle interior surface. A decorative layer 29 illustratively includes flocking, textile, carpet, leather, textured soft-touch plastic, thermoplastic film, or a combination thereof.

According to certain inventive embodiments, the composite sandwich panel assembly provides sound damping, fire retardancy, thermal insulation, or a combination thereof by placing a sound and/or heat absorbing material within the pores 24 of the low-density core 12. According to embodiments, the pores 24 of the low-density core 12 are at least partially filled with a fill 49. The fill illustratively including foam pellets, fire retardant, or a phase change material. Phase change materials operative herein include waxes or an inorganic salt hydrates.

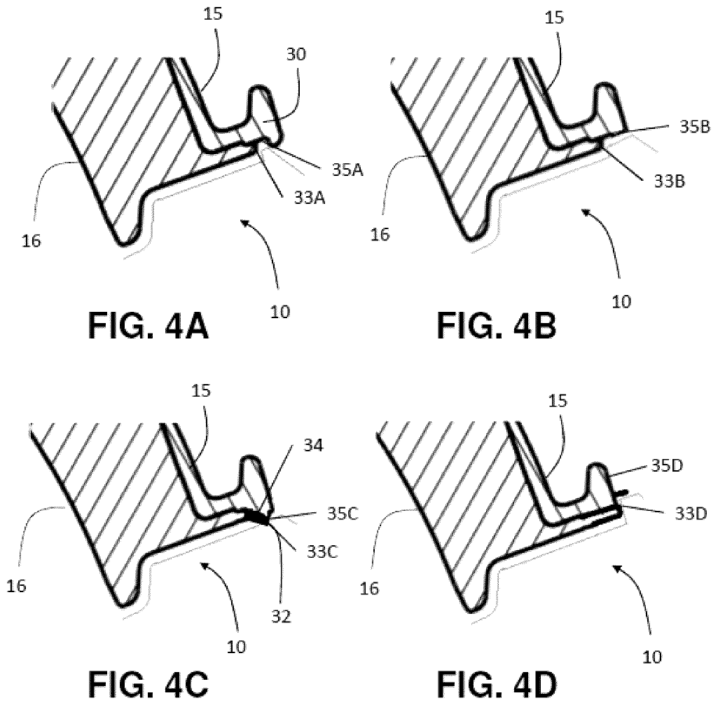

According to embodiments, the outermost layers such as the high gloss surface sheet 14 and the structural skin 16 are joined together along an edge 33A-33D of the composite sandwich panel assembly to form a seal, as shown in FIGS. 4A-4D, respectively. In certain inventive embodiments in which all of the edges of the composite sandwich panel assembly 10 are sealed, the low-density core 12 is fully enclosed and moisture is inhibited from entering the interior of the composite sandwich panel assembly 10. In some situations, depending on the intended use and location of a part formed of the composite sandwich panel assembly 10, preventing moisture from entering the interior of the composite sandwich panel assembly 10 is important given that freeze thaw cycles of moisture within the part cause expansion and potentially failure of the assembly 10. Additionally, in embodiments in which the low-density core 12 is formed of a hydrophilic material such as paper, moisture within the composite sandwich panel assembly 10 would destroy the low-density core 12 and cause the part to fail.

FIGS. 4A-4D show various embodiments of ways in which the high gloss surface sheet second layer 14 and the structural skin third layer 16 are joined together to form a sealed edge 33A-33D, respectively according to the present disclosure. In some inventive embodiments an elastomeric gasket 34 is disposed between the high gloss surface sheet second layer 14 and the structural skin third layer 16 at the 33C to make the edge 33C more water resistant. It is appreciated that a gasket is readily included in the other edge joinder 33A, 33B, and 33D. The gasket 35 enhances maintenance of the edge seal over a wider range of use conditions.

As will be understood by one having ordinary skill in the art, to form an edge seal between the second layer 14 and the third layer 16, at least one of the second layer 14 and the third layer 16 requires enough material to wrap around the edge of the composite sandwich 10. According to certain inventive embodiments, at least one of the second layer 14 and the third layer 16 is provided in dimensions greater than the dimensions of the final composite part such that the material is able to wrap around the final edge composite sandwich 10. According to certain inventive embodiments, the at least one of the second layer 14 and the third layer 16 is preformed such that it has edges extending generally perpendicularly from the plane of the sheet material. Notably, manufacturing of such a sealed edge finish would be excessively difficult if the surface sheet 14 or structural skin 16 were formed out of traditional materials such as aluminum. That is, given that according to some embodiments, the structural skin 16 is formed of a glass mat reinforced polyurethane material and is pushed into the high gloss surface sheet 14 formed of SMC using the shear edge, the manufacturing process for sealing the honeycomb is easier than if the honeycomb were covered with a traditional material such as aluminum.

According to certain inventive embodiments, excess material is cut from the composite sandwich once the edge seal is formed. As shown in FIG. 4A, excess material of the structural skin third layer 16 has been trimmed from the composite sandwich assembly 10 by a knife or router that presses against the divot 35A that is formed by the high gloss surface sheet second layer 14. In FIG. 4B, the edge 33B formed by removing excess material for tool engagement against a shoulder 35B of the high gloss surface sheet second layer 14. In FIG. 4C, the edge 33C formed by removing excess material for tool engagement against a shoulder 35C of the high gloss surface sheet second layer 14. Also, as shown in FIG. 4D, excess material of one or both the high gloss surface sheet second layer 14 and the structural skin third layer 16 are trimmed with tool pressure against shoulder 35D. It is also noted that the edge region of the low-density core 12 often crushes during a press molding to form the edge seal. The crushing of the pores 24 of the low-density core 12 near the edge that is crushed in order to form a seal also contribute to moisture absorption inside the low-density core. That is, the crushed region of the low-density core aids in suppressing moisture absorption of the low-density core.

The present disclosure further provides a process for forming the composite sandwich structure 10 according to embodiments of the invention. A process for forming a composite sandwich panel assembly 10 according to the present invention includes applying a first UV curable adhesive 20 on a first face 17 of a first layer 12, embedding a length of a first optical fiber 40 in the first UV curable adhesive 20 while leaving a first end 42 of the first optical fiber 40 free of the first adhesive 20, applying a second layer 14 to the first UV curable adhesive 20 on the first face 17 of the first layer 12, and applying UV light to the first end 42 of the first optical fiber 40 so that the UV light is emitted along the length of the first optical fiber 40 to cure the first UV curable adhesive 20. According to embodiments, the process additionally includes applying a second UV curable adhesive 22 on a second face 17′ of a first layer 12, embedding a length of a second optical fiber 40′ in the second UV curable adhesive 22 while leaving a first end 42′ of the second optical fiber 40′ free of the second adhesive 22, applying a third layer 16 to the second UV curable adhesive 22 on the second face 17′ of the first layer 12, and applying UV light to the first end 42′ of the second optical fiber 40′ so that the UV light is emitted along the length of the second optical fiber 40′ to cure the second UV curable adhesive 22. According to embodiments, the UV light is applied to the first optical fiber 40 and the second optical fiber 40′ at the same time so that the first adhesive layer 20 and the second adhesive layer 22 are cured at the same time.

According to embodiments, the adhesive 20, 22 is applied by spraying, painting, or extruding a UV curable adhesive onto either the first layer 12, the second layer 14, or the third layer 16. The optical fiber 40, 40′ may be applied to the adhesive layers 20, 22 at the same time as the adhesive or before or after the adhesive is applied. The optical fiber 40, 40′ may be applied by hand or by a machine. The optical fiber 40, 40′ may be applied in any suitable pattern that distributes the optical fiber 40, 40′ through the adhesive 20, 22 so that UV light is able to reach the entirety of the UV curable adhesive so that the UV curable adhesive can be cured. According to embodiments, the optical fiber 40, 40′ is applied as a woven or non-woven fiber mat such as cloth 19. A UV curable adhesive operative herein illustratively includes those detailed in U.S. Pat. No. 6,613,438 B1.

According to some inventive embodiments, the process for forming the composite sandwich structure 10 further includes applying a decorative layer 29 to a surface 31 of the stack. In some embodiments, the decorative layer 29 is a vehicle interior surface. It is appreciated that the relative ordering of joinder between the various layers can be reversed relative to that detailed above, and in still other embodiments, both the second layer 14 and the third layer 16 are simultaneously joined to the first layer 12. It is further appreciated that the second layer 14 and the third layer 16 are each independently positioned with outward surface 15 and 31 respectively, positioned above, below, or laterally displaced relative to the first layer 12 during joinder.

According to embodiments, the inventive process further comprises at least one of compression molding or vacuum molding the composite sandwich panel 10 once the first layer 12, second layer 14, third layer 16, and adhesive layers 20, 22 have been assembled together. Such compression molding and/or vacuum molding forms the composite sandwich panel 10 to a component suitable to use as a vehicle component. According to embodiments, the compression molding and/or vacuum molding steps bring the edges of the second layer 14 and the third layer 16 together along at least one edge of the composite sandwich panel assembly 10 to form a seal along the edge. According to embodiments, at least one of the second layer 14 and the third layer 16 is preformed such that it has edges extending generally perpendicularly from the plane of the sheet material, this edge providing sufficient material such that the edges of the layers 14, 16 can be joined together.

Excess material is removed from the edges after the seal is formed between the layers 14, 16 16 with resort to a trimming tool conventional to the art.

The foregoing description is illustrative of particular embodiments of the invention but is not meant to be a limitation upon the practice thereof. The following claims, including all equivalents thereof, are intended to define the scope of the invention.

The invention claimed is:

1. A composite sandwich panel assembly comprising:
a first layer having a first face and a second face opposing the first face;
a first adhesive provided on the first face of the first layer, the first adhesive being a UV curable adhesive;
a first optical fiber having a first end, a second end, and a length therebetween, the length of the first optical fiber embedded within the first adhesive and the first end of the first optical fiber being free of the first adhesive, the first optical fiber having a refraction index such that UV light applied to the first end of the first optical fiber is emitted along the length of the first optical fiber;
a second layer adhered to the first face of the first layer by the first adhesive.

2. The composite sandwich panel assembly of claim 1 wherein the first adhesive is transparent.

3. The composite sandwich panel assembly of claim 1 wherein the first layer is a low density core defining a plurality of pores.

4. The composite sandwich panel assembly of claim 3 wherein the low density core is formed of at least one of a cellulosic, thermoplastic, thermoset, metal, or foam.

5. The composite sandwich panel assembly of claim 3 wherein the plurality of pores define an array of at least one shape of hexagonal, circular, rhomboidal, triangular, parallelogram quadrilateral, or regular quadrilateral.

6. The composite sandwich panel assembly of claim 1wherein the second layer is one of a high gloss surface sheet or a structural skin.

7. The composite sandwich panel assembly of claim 6 wherein the high gloss surface sheet is present and formed of any one of: sheet molding compound (SMC), thermoplastic sheet, dicyclopentadiene (DCPD), or overmolded polyurethane (PU).

8. The composite sandwich panel assembly of claim 7 wherein the high gloss surface sheet is present and comprises a filler of at least one of: glass fiber, carbon fiber, carbon nanotubes, graphene, inorganic particulate fillers, glass microspheres, low profile additives, or moisture scavengers.

9. The composite sandwich panel assembly of claim 6 wherein the high gloss surface sheet is present and has a thickness of from 0.5 to 3.5 mm.

10. The composite sandwich panel assembly of claim 6 wherein the structural skin is present and formed of a fiber mat.

11. The composite sandwich panel assembly of claim 1 further comprising a third layer adhered to the second face of the first layer by a second adhesive provided on the second face of the first layer.

12. The composite sandwich panel assembly of claim 11 wherein the second adhesive is a UV curable adhesive with a length of a second optical fiber embedded therein, the second optical fiber having a refraction index such that UV light applied to a first end of the second optical fiber is emitted along the length of the second optical fiber.

13. The composite sandwich panel assembly of claim 11 wherein the third layer is one of a high gloss surface sheet of a structural skin.

14. The composite sandwich panel assembly of claim 13 wherein the high gloss surface sheet is present and formed of any one of: sheet molding compound (SMC), thermoplastic sheet, dicyclopentadiene (DCPD), or overmolded polyurethane (PU).

15. The composite sandwich panel assembly of claim 14 wherein the high gloss surface sheet is present and comprises a filler of at least one of: glass fiber, carbon fiber, carbon nanotubes, graphene, inorganic particulate fillers, glass microspheres, low profile additives, or moisture scavengers.

16. The composite sandwich panel assembly of claim 13 wherein the high gloss surface sheet is present and has a thickness of from 0.5 to 3.5 mm.

17. The composite sandwich panel assembly of claim 13 wherein the structural skin is present and formed of a fiber mat.

18. The composite sandwich panel assembly of claim 11 wherein the second layer and the third layer are joined together to form an edge defining a moisture resistant seal.

19. The composite sandwich panel assembly of claim 18 further comprising a gasket disposed between the second layer and the third layer at the edge.

20. A process for forming a composite sandwich panel assembly, the process comprising:
applying a first UV curable adhesive on a first face of a first layer;
embedding a length of a first optical fiber in the first UV curable adhesive while leaving a first end of the first optical fiber free of the first adhesive, first optical fiber having a refraction index such that UV light applied to the first end of the first optical fiber is emitted along the length of the first optical fiber;
applying a second layer to the first UV curable adhesive on the first face of the first layer; and
applying UV light to the first of the first end optical fiber so that the UV light is emitted along the length of the first optical fiber to cure the first UV curable adhesive.
